(19) United States
(12) Patent Application Publication
(10) Pub. No.: US 2010/0126327 A1
(43) Pub. Date: May 27, 2010

(54) Concrete joint cutting and routing blade

(76) Inventor: Robert Joseph Cabral, Orange Park, FL (US)

Correspondence Address: Robert J Cabral, Building #27, P.O. Box 139, Jacksonville, FL, 32212-0139, US

(21) Appl. No.: 12/313,758

(22) Filed: Nov. 25, 2008

(51) Int. Cl. B27B 33/08

(52) U.S. Cl. 83/835

(57) ABSTRACT

Provided are two outer-diameter blade with an inner routing section for cutting and removing existing concrete joint material. A three section routing/cutting saw blade includes a circular middle core having sectors defined about the periphery, a pair of side cores disposed adjacent peripheries, and pluralities of outer and inner cutting segments are secured to the respective middle core sectors and side core plates. Each side core is larger in diameter than the middle core such that the side core plates and inner routing segments thereon are displaced redial inwardly from the middle core sectors and outer cutting segments secured thereon, thereby adapting the blade for cutting and routing existing sealant system from joint between concrete plate sections. An outer section of the blade comprises; a metal plate having a disk-like shape; a diamond abrasive grain layers formed on side surfaces of the metal base plate, wherein an outer end face of the tip portion is shaped as an angled protrusion. An inner section of the blade comprises; metal plate having a disk like shape; outer end having a tempered harden edge, wherein an outer end face of the tip portion is shaped as an angled protrusion, and plurality of cutting/routing teeth provide along the peripheral edge.

### CROSS-REFERENCE TO RELATED APPLICATIONS

### References Cited [Referenced By]

U.S Patent Documents

| | | |
|---|---|---|
| 1,362,187 | Dec. 22, 1964 | Christensen |
| 3,291,583 | Dec. 13, 1966 | Lindblad |
| 3,338,230 | Aug. 17, 1967 | Lindbald |
| 3,599,622 | Aug. 17, 1971 | Baron |
| 4,461,268 | Jul. 24, 1984 | Inoue |
| 4,624,237 | Nov. 25, 1988 | Inoue |
| 4,718,398 | Jan. 12, 1988 | Hallez |
| 4,739,745 | April 1988 | Brauning |
| 4,854,295 | Aug. 8, 1989 | Sakarcan |
| 4,962,748 | Oct. 16, 1990 | Schweickhardt |
| 4,270,429 | Jun. 2, 1981 | Brown |
| 4,337,750 | Jul. 6, 1982 | Dutcher |
| 4,516,560 | May 14, 1985 | Ekland |
| 4,690,024 | Sep. 1, 1987 | Chaconas |
| 4,766,794 | Aug. 30, 1988 | Blake |
| 4,848,205 | Jul. 18, 1989 | Suzuki |
| 4,930,487 | Jun. 5, 1990 | Young |
| 5,038,653 | Aug. 13, 1991 | Gray |
| 5,361,665 | Nov. 8, 1994 | Sonefors |
| 7,013,784 | Mar. 21, 2006 | Lowder |

### Current U.S. Class:

125/13.01; 125/15; 451/547

### Current International Class:

B28D1/02 (20060101); B24D 5/12 (20060101); B24D 5/00 (20060101); B28D 1/12 (20060101); B24B 27/06 (20060101); B28D 001/04 (20060101); B23D 61/00 (20060101); B24D 005/06 (20060101)

### Field of Search:

125/15, 125/13.01, 451/548

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

1) The present invention relates to circular saw blade used to cut and clean concrete expansion and construction joints. More particularly, is concerned with removal of joint material and preparation of surfaces for reconstruction of the concrete slab joint sealing system.

2) For many years concrete pavement has been design with expansion and construction joints for highways, airport aprons, airport hangar floors, fuel depot slabs, bridge slabs and parking garages pavements to handle to movement between the concrete slabs. Engineers design joints to deal with shifting from soil settlement and movement cause by seasonal temperature change. These joints are normally sealed to control water tightness, environmental protection, coating preparation and general appearance.

3) Current technology in use to remove/cut existing material joints involves thin concrete saw blades to cut the bond between the sealant and the concrete joint walls. On the first pass the sealant is separated from the joint wall then, second pass to cut bond of the sealant and the joint wall on the opposite side of the joint first cut. The filler materials that remain in the joint are then removed as a separate operation in preparation for the new sealant.

### SUMMARY OF THE INVENTION

This blade has three components. The outer sections are designed to control the boundaries of the removal process. Each outer section of the blade is design with a diamond abrasive grain tip portion along an outer peripheral part of the base metal plate. The inner center section has routing teeth that will remove the material between the two boundary blades. The center section will cut and remove waste material as well as control the travel speed of the joint cutting. As the outer plates cut ahead of the center section, the amount of inner material removal is controlled as the blade advance. When the outer plates reach 1¼ inch depth, the inner section will be at 1 inch depth (this depth is based on a ½ inch wide joint). Normal joint design, the depth of the cavity will need to be two times the width. The lower half of the cavity will be filled with a backing rod. The upper section of the cavity is then filled with new sealant material. The most important part of the joint is the bond between the new sealant and the concrete wall surfaces. Also, the cross section of the joint at the center is another point of interest, at this location is where the elastic movement will take place when the concrete move. The new joint profile is developed by the backing rod shape. The quality of the finish joint is directly related to the quality of the removal operation. My invention can provide a unique ability of controlling both the depth of the cut and maintain the overall level of quality of the wall cleaning over the full length of the joint being cut. Because this invention will make it much easier to remove the concrete material, the efficiency and speed of the joint preparation will be improved over the current method being employed.

### BRIEF DESCRIPTION OF THE DRAWINGS

FIG. 1 is a perspective view of the present invention illustrating the three components of the cutting blade.

FIG. 2 is a plan views of one (of two) outer cutting component or outer section. This element of the present invention provides the cutting function between the concrete wall and the existing sealant material as well as performing the concrete cleaning operation. This section also, provides control limit to the depth material being removed and width of the joint preparation.

FIG. 3 is a side view of the outer component or cutting sections.

FIG. 4 is a plan view of the router component which will cut and remove the existing material in the center of the expansion joint. This section of the present invention also will establish the foundation profile for the new sealant material.

FIG. 5 is a side view of the router component showing the convex shape of the cutting edge which set up the existing material profile to receive the new round backing rod. This component also establishes the depth of material removal which is critical to the successful reconstruction of the expansion joint sealant system.

FIG. 6 is plans view of one (of two) outer cutting component or outer section. This element of the present invention provides the cutting function between the concrete wall and the existing sealant as well as performing the concrete cleaning operation. This section also provide control limit to the depth material being removed.

FIG. 7 is a side view of the outer component or cutting edge.

FIG. 8 is a cutaway view thru a expansion joint showing the routing component in position removing the existing center material and the cutting components cutting the joint walls as well as cleaning the surface by removal of a thin layer of concrete surface.

FIG. 9 is a side view of the present invention in operation showing the relationship of each component in the removal operation. Note the depth of cut of the outer components and the depth of removal of the center material. Successful reconstruction of the expansion joint relies on the positioning of the new backing rod to maximums the working elements functions when placed into service.

### DETAILED DESCRIPTION OF THE INVENTION

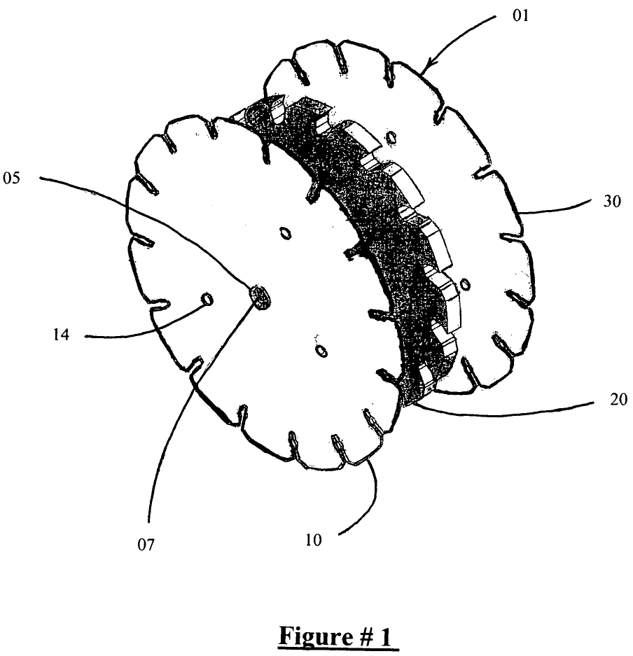

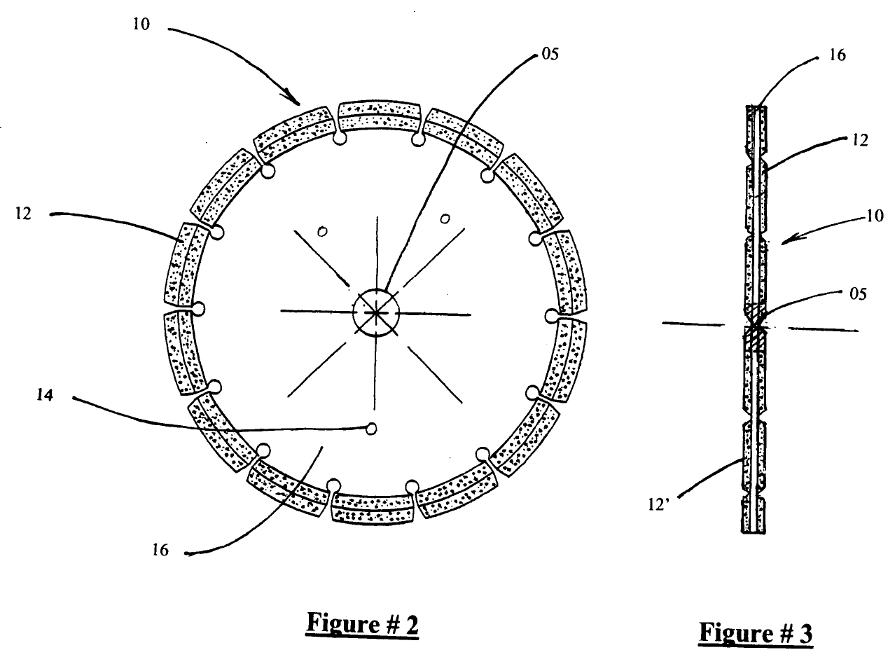

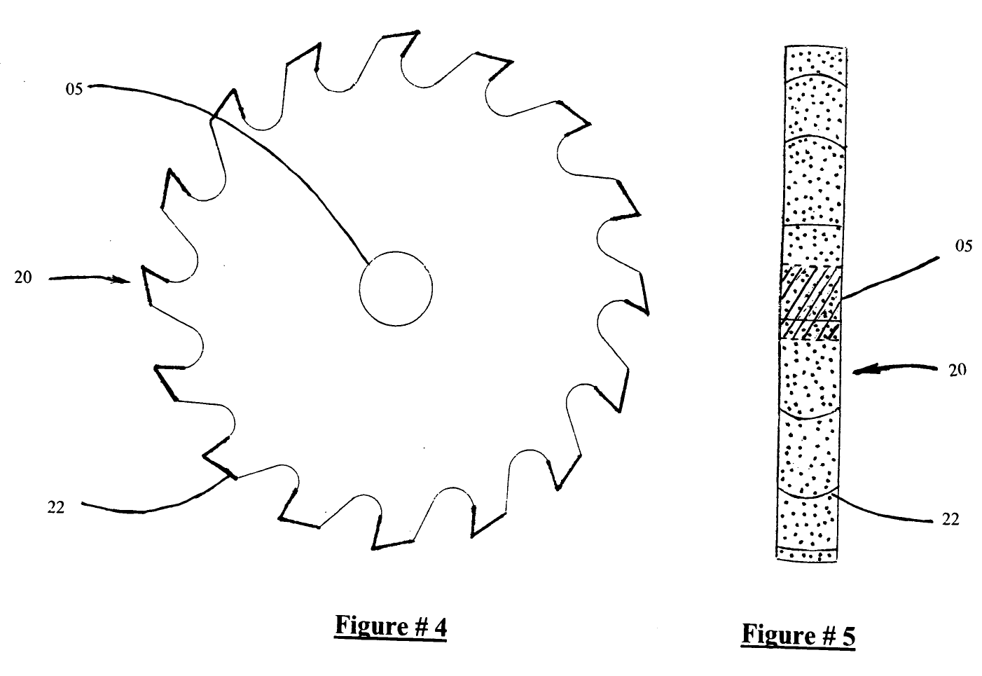

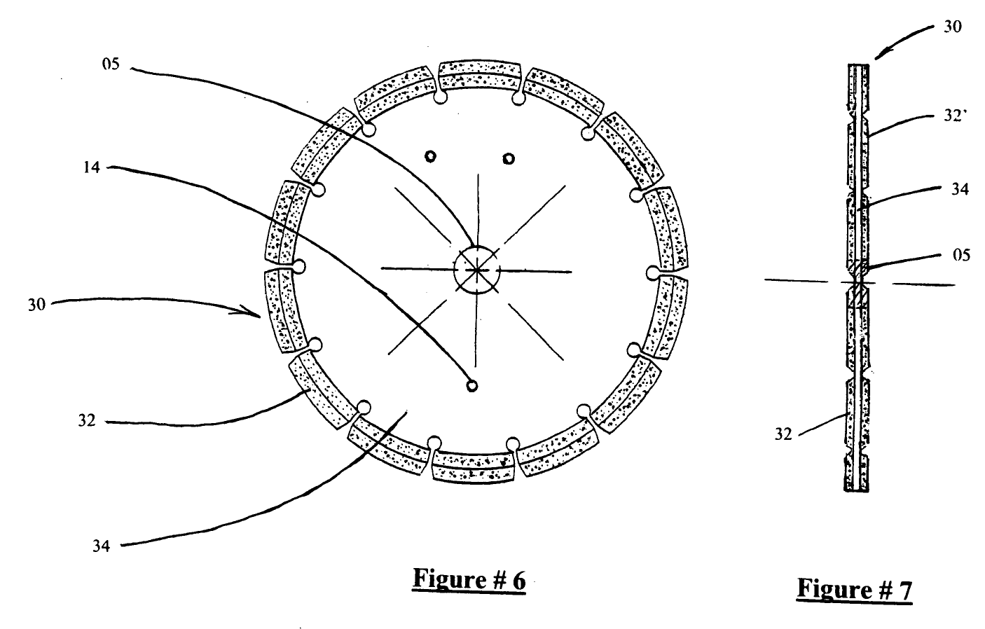

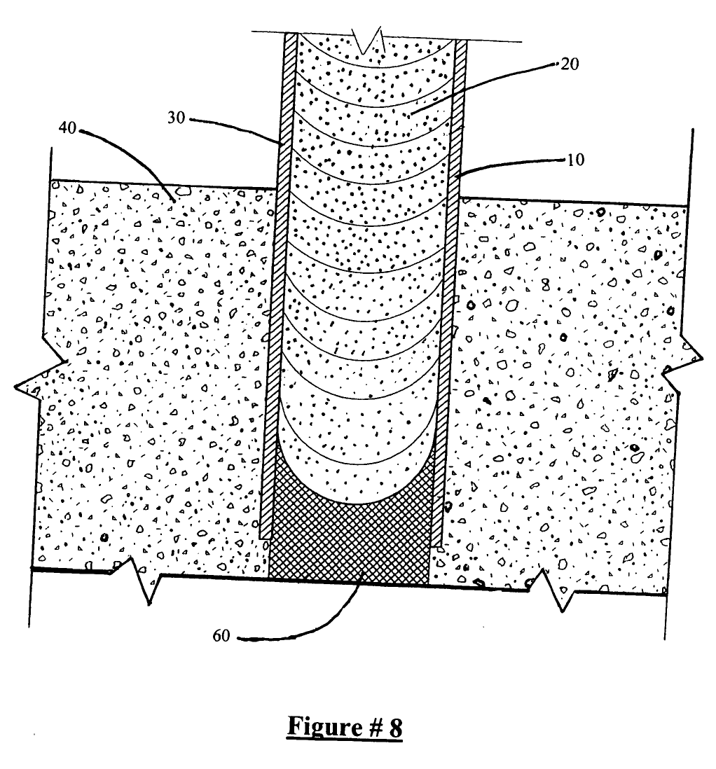

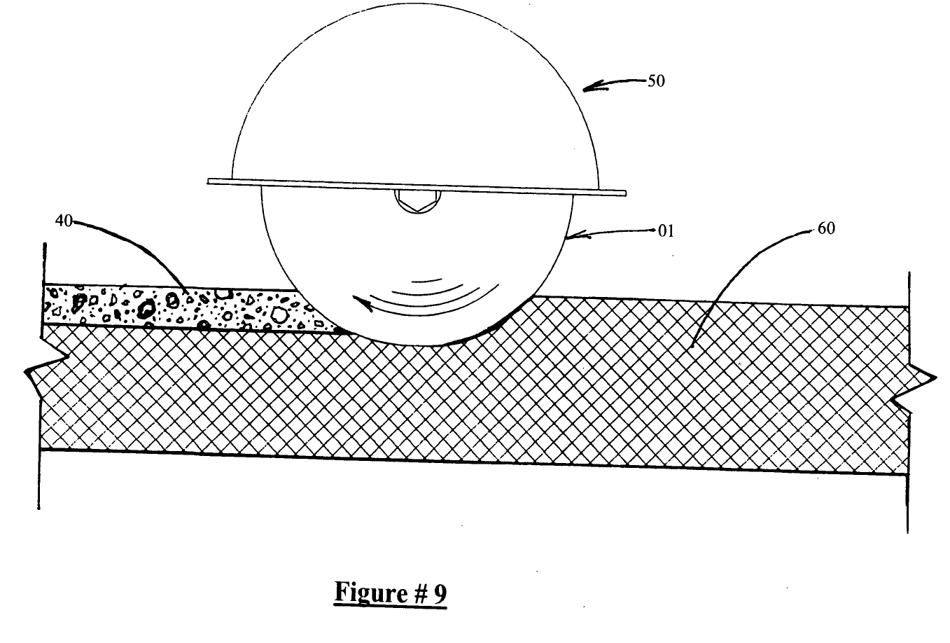

This invention (referring to FIG. 1) is comprised of three components (01). Each outer section (referring to FIGS. 1, 2, 3, 6, 7) (10, 30) consists of a flat round metal plate (16, 34) with a mounting hole (05) in the center which is sized and shaped for a arbor (referring to FIG. 1) (07). At the outer edge (referring to FIGS. 2, 6) (10, 30) on both side there is ½″ to ¾″ diamond abrasive band (referring to FIGS. 1, 2, 3, 6, 7) (12, 12′, 32, 32′) for cutting the bond between the existing sealant and concrete surface. The center component (referring FIGS. 4, 5, 8) (20) is design with harden steel teeth and coated over with a diamond abrasive material to route out the existing sealant material (referring FIGS. 8, 9) (60) while the outer components (referring FIG. 8) (10, 30) control amount of existing backing material being removed. This center section of the blade cuts and controls the depth of the cut to ensure the joint profile. All three components are plug welded to each other (referring to FIG. 1) (14) for uniformed motion during the cutting/routing operation. As the invention travels down the existing joint this blade clean the concrete wall (referring FIGS. 8 & 9) (40) to improve the bond between the new sealant and the concrete wall. The saw (referring FIG. 9) (50) provide depth control (referring FIG. 9) (40, 60) by holding the blade in the joint cavity at the same level for the length of cut. This blade will deposit the waste materials outside the joint cavity. Thus a three pass operation is reduced to a single pass operation.

I claim:

1. A circular saw blade for cutting/routing of concrete expansion joint sealant material, comprising:
(a) A substantially circular middle core having a center, a periphery and a pair of opposite surfaces, said middle core including a plurality of sectors defined in circumferentially space relation to one another relative to said center and along said periphery of said middle core:
(b) A plurality of outer cutting segments secured to said respective sectors of said middle core, each said outer cutting segment having a width less than the thickness of said middle core between said opposite surface thereof such that said outer cutting segments extend beyond said opposite surfaces of said middle core and are operable for cutting material bond between the sealant and the concrete surface;
(c) A pair of substantially circular side cores, each said side core having a center, a periphery and a pair of opposite surfaces, each said core being disposed adjacent to one of said opposite surfaces of said middle core, each said side core including a plurality of lands defined in circumferentially spaced relation to one another relative to said center and along said periphery of said side core, each said side core being larger in diameter than said middle core such that said lands of said side cores are displaced radial outwardly from said sectors of said middle core;
(d) A plurality of inner routing segments secured to said respective lands of each said side core, said inner routing segments on one of said side cores being aligned with one of said inner routing segments on the other of said side cores, said inner routing segment having a width less than the width of each said outer cutting segments and greater than the thickness of each said side core between said opposite surfaces thereof such that said inner routing segment does not extend beyond said ones of said side opposite surfaces of said cores that face away from said middle core and are operable for cutting existing joint sealant material and removal operation;
(e) side cores, said inner routing segment having a width less than the width of each said outer cutting segments and greater than the thickness of each said side core between said opposite surfaces thereof such that said inner routing segments does not extend beyond said ones of said opposite surfaces of said side cores that face away from said middle core and are operable for cutting existing joint sealant material and removal operation;
(f) Said middle core having a plurality of windows defined there through adjacent to and extending radial outwardly from said respective lands of said cores, said aligned inner routing segments on said respective side cores projecting toward one another into said windows of said middle core.

2. The blade as recited in claim 1, wherein said aligned inner routing segments on side cores have substantially identical L-shaped configurations in cross-section being oriented in reverse of one another.

3. The blade as recited in claim 1, wherein said aligned inner routing segments on said side cores are abutting one another within said windows of said middle core.

4. The blade as recited in claim 1, wherein said aligned inner routing segments on said side cores are spaced from one another within said windows of said middle core.

5. A circular saw/routing blade for removing cured concrete joint sealant material:
(a) A substantially circular middle core having a center, a periphery and a pair of opposite surfaces, said middle core including a plurality of sectors defined in circumferentially spaced relation to one another relative to said center and along said periphery of said middle core;
(b) A plurality of outer cutting segments secured to said respective sectors of said middle core, each said outer cutting segments having a width less than the thickness of the said middle core between said opposite surfaces thereof such that outer cutting segments extend beyond said opposite surfaces of said middle core and are operable for cutting existing bond between concrete joint sealant material;
(c) A pair of substantially circular side cores, each said side core having a center, a periphery and a pair of opposite surfaces, each said side core being disposed adjacent to one of said opposite surfaces of said middle core, each said side core including a plurality of lands defined in circumferentially spaced relation to one another relative to said center and along said periphery of said side core, each said side core being larger in diameter than said middle core such that lands of said side cores are displaced radial outwardly from said sectors of said middle core;
(d) A plurality of inner routing segment secured to said respective lands of each said side core, each of said routing segment on one of said side cores being aligned with one of said routing segment on the other of said side cores, said routing segments having a width smaller than the width of each said outer cutting segments and greater thickness than the thickness of each said side core between said opposite surfaces thereof such that said inner routing segments indented from said both of said outer opposite surfaces of said side cores that face away from said middle core and are operable for removing concrete joint sealant material;
(e) Said middle core having a plurality of recesses defined in each of said opposite surfaces thereof adjacent to and extending radial outwardly from said respective plates of said side cores, each said recess on one of said opposite surfaces of said middle core being aligned with one of said recesses on the other of said opposite surfaces of said middle core, said aligned inner routing segments on said respective side cores projecting toward one another into said aligned recesses of said middle core.

6. The blade as recited in claim 5, wherein said aligned inner routing segments on said inner cores have substantially flat-shaped configurations in cross-section.

7. The blade as recited in claim 5, wherein said aligned inner routing segment of said side cores have substantially identical L-shaped configurations in cross-section being oriented in reverse of one another, are spaced from one another by the thickness of said middle core between said recesses thereof.

8. A circular saw blade for removing existing joint sealant material comprising:
(a) A substantially circular middle core having a center, a periphery and a pair of opposite surfaces, said middle core including a plurality of sector defined in circumferentially spaced relation to one another relative to said center and along said periphery of said middle core;
(b) A plurality of outer cutting segments secured to said respective sector of said middle core, each said outer cutting segment having a thickness less than the thickness of said middle core between said opposite surfaces thereof such that said outer cutting segments extend beyond said opposite surfaces of said middle core and are operable for cutting the bond between the concrete surface and sealant;
(c) A pair of substantially circular side cores, each said side core having a center, a periphery and a pair of opposite surfaces, each said side core being disposed adjacent to one of said opposite surfaces of said middle core, each said side core including a plurality of lands defined in circumferentially spaced relation to one another relative to
(d) said center and along said periphery of said side core, each said side core being larger in diameter than said middle core such that said lands of said side cores are displaced parallel from said sector of said middle core;
(e) A plurality of inner routing segments secured to said respective lands of each said side cores of said aligned inner routing segment having a width less than the width of each said outer cutting segments and greater than the thickness of each said core between said opposite surfaces thereof such that said inner routing does not extend beyond said opposite surfaces of said side cores that face away from said middle core and are operable for removing existing joint material from the concrete joint; and
(f) Inner means on said middle and side cores at predetermined locations thereon between said center and periphery of said middle core and between preselected ones of said lands of said side cores for defining an existing path away from said inner routing/cutting segments for flow of material particles generated from routing/cutting of the joint material and flashing of the groove by fluid coolant so as to reduce wear and undercutting of the core adjacent to the inner routing/cutting segment.

9. The blade as recited in claim 8, whereas said core are substantially identical to one another.

10. The blade as recited in claim 8, wherein said inner means includes a plurality of openings defined in said middle core at said predetermined locations.

11. The blade as recited in claim 10, wherein each said opening of said inner means has a center which lies on a circle generated about said center of said middle core by radius extending from said center of said middle core to a routing/cutting edge of said inner plowing segment.

12. The blade as recited in claim 10, wherein each said opening is circle/rectangular in configuration and has length and width dimensions extending substantially parallel to respective orthogonal axes which extend through said center of said middle core.

13. The blade as recited in claim 10, whereas each said opening is substantially oblong in configuration and has a length dimension extending substantially radial relative to said center of said middle core.

14. The blade as recited in claim 10 wherein said inner means also includes a plurality of filler segments disposed in said openings and secured to portions of said middle core adjacent to said openings.

15. The blade as recited in claim 14, wherein said inner means further includes a plurality of cutouts defined in each side predetermined locations thereon between said preselected ones of said lands of said side cores.

16. The blade as recited in claim 15, wherein said openings and said filler segments of said middle core and said cutouts of each said core are less in number than said lands of each said side core and said inner cutting/routing segment on each said side core.

17. A circular saw blade for cutting/routing existing concrete expansion joint sealant,
(a) A substantially circular middle core having a center, a periphery and a pair of opposite surfaces, said middle core including a plurality of sectors defined in circumferentially spaced relation to one another relative to said center and along said periphery of said middle core;
(b) A plurality of outer cutting segments secured to said respective sectors of said middle core, each said outer cutting segment having a thickness less than the thickness of the said middle core between said opposite surfaces thereof such that said outer cutting segments extend beyond said opposite surface of said middle core and are operable for cutting sealant bond between concrete surfaces;
(c) A pair of substantially circular side cores, each side core having a center, periphery and a pair of opposite surfaces, each said side core being disposed adjacent to one of said opposite surfaces of said middle core, each said side core including a plurality of lands defined in circumferentially spaced relation to one another relative to said center and along said periphery of said side core, each said side core being larger in diameter than middle core such that said lands of said side cores are displaced radial inwardly from said sectors of said middle core;
(d) A inner routing/cutting segment secured to said respective lands of each said side core, said inner routing/cutting segment having a width less then the width of each said outer cutting segments and greater than the thickness of each said side core between said opposite surfaces thereof such that said outer cutting segments extend beyond said one inner core and are operable for cutting the bond between the sealant and concrete surfaces being rehabilitated; and
(e) Means for attaching said side core with said middle core at locations about said peripheries of said cores.

18. The blade as recited in claim 17, wherein each of said outer cutting segments on one of said inner core is aligned with one of said outer cutting segments on the other of said cores, said aligned inner routing segment on said side cores have substantially identical L-shaped configurations in cross-section being oriented in reverse of one another.

19. The blade as recited in claim 17, wherein said side core are substantially identical to one another.
